(19) United States
(12) Patent Application Publication
(10) Pub. No.: US 2024/0357032 A1
(43) Pub. Date: Oct. 24, 2024

(54) Location Filtering Of Digital Emergency Alerts For Automotive And Mobile Devices

(71) Applicant: iBiquity Digital Corporation, Columbia, MD (US)

(72) Inventor: Ashruf El-Dinary, Columbia, MD (US)

(21) Appl. No.: 18/686,180

(22) PCT Filed: Aug. 23, 2022
(86) PCT No.: PCT/US2022/041197

§ 371 Date: Feb. 23, 2024

Related U.S. Application Data
(60) Provisional application No. 63/236,391, filed on Aug. 24, 2021.

(51) Int. Cl. H04M 1/72421; H04M 1/72436; H04M 1/72457

(52) U.S. Cl. CPC H04M 1/72421; H04M 1/72436; H04M 1/72457

(57) ABSTRACT

Embodiments of a method for rendering an alert message at a user device and of an emergency alert location filtering system are disclosed. In an embodiment the method comprises determining a current geographical location of the user device, receiving alert messages, each alert message comprising message information and a geographical code, and configuring an alert filter at the user device to allow alert messages to pass the alert filter for rendering at the user device that comprise a geographical code which corresponds to a geographical area in which the current geographical location of the user device is located.

### RELATED APPLICATION AND PRIORITY CLAIM

This application is related to and claims priority to U.S. Provisional Application No. 63/236,391, filed on Aug. 24, 2021, and entitled “LOCATION FILTERING OF DIGITAL RADIO EMERGENCY ALERTS FOR AUTOMOTIVE AND MOBILE DEVICES,” which is hereby incorporated by reference in its entirety.

### BACKGROUND

Over-the-air radio broadcast signals are used to deliver a variety of programming content (e.g., audio, etc.) to radio receiver systems. Such over-the-air radio broadcast signals can include conventional AM (amplitude modulation) and FM (frequency modulation) analog broadcast signals, digital radio broadcast signals, or other broadcast signals. Digital radio broadcasting technology delivers digital audio and data services to mobile, portable, and fixed receivers. One type of digital radio broadcasting, referred to as in-band on-channel (IBOC) digital audio broadcasting (DAB), uses terrestrial transmitters in the existing Medium Frequency (MF) and Very High Frequency (VHF) radio bands.

It is known to broadcast emergency alert notifications through conventional and digital radio broadcasting systems. For example, specific channels for alerts may be provided in a digital radio broadcasting system. Modern emergency alert notifications and digital emergency alerts utilize geographical location to highlight the relevant areas for the alert. By filtering the alert notifications based on geographical location such as a home geographic area, alert notifications for particular geographical areas can be rendered at a user device.

While filtering of alert notifications based on geographical location is sensible for stationary applications, for mobile and car applications, filtering alert messages based on home or local geographic area will not allow a user device to receive alert notifications other than those intended for the home or local geographic area. The present inventor has observed that it would be desirable to provide methods and systems that improve the receipt of relevant alert messages in mobile and car applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Aspects of the present invention provide for an emergency alert location filtering method and system for smart location filtering of digital radio (such as HD Radio™ from iBiquity Digital Corporation in Columbia, Maryland) emergency alerts based on matching geographical codes (or “geo-codes”) in the alert with instantaneous knowledge and/or predictive tracking of the device location and/or route.

Embodiments of the system and method disclosed herein use novel techniques to manage the geographical location (or “geo-location”) filtering of emergency alert messages in mobile use cases. In an embodiment, a method for rendering an alert message at a user device that is in a moving condition and thus changing its geographical location is provided. The method comprises determining a current geographical location of the user device, receiving alert messages, each alert message comprising message information and a geographical code, and configuring an alert filter at the user device to allow alert messages to pass the alert filter for rendering at the user device that comprise a geographical code which corresponds to a geographical area in which the current geographical location of the user device is located.

In a further embodiment, an emergency alert location filtering system of a user device is provided. The filtering system comprises: a receiver module configured to receive alert messages that comprise message information and a geographical code; a GPS/navigational module configured to determine a current geographical location of the user device and/or configured to determine a route between a current geographical location and a destination geographical location; a human machine interface; a processor coupled to the receiver module, the GPS/navigational module and the human machine interface; and a memory storing instructions. The instructions, when executed by the processor, configure the processor to allow alert messages to pass from the receiver module to the human machine interface that comprise a geographical code which corresponds to a geographical area in which the current geographical location of the user device is located.

Accordingly, a novel method and system are provided which allow to dynamically adjust the alert filter for relevant warnings and notifications based at least on the current position of a user device.

Alert messages in the context of the present invention may be any kind of message that serves to provide a user with specific information of urgency. The alert messages may be emergency alerts or other emergency notifications. Examples include weather alerts and security alerts (such as an alert regarding a wrong way driver or a fire alarm). The alert messages may also include commercial alerts.

An alert filter in the context of the present invention is any filtering means that allows to limit the number of received alerts messages that are brought to the attention of a user. The alert filter may be implemented in a plurality of ways. The alert filter may be formed by applying in a process flow at least one criteria to a received alert message and by determining if the respective criteria is met by the received alert message. The alert filter may be implemented in software and/or hardware.

Embodiments of the emergency alert location filtering system and method may be implemented within a host device or application software for virtually any digital radio product, such as HD Radio™, DAB+, DRM, CDR, and many others.

In some embodiments the geo-codes are Federal Information Processing System (FIPS) codes, in other embodiments the codes are Specific Area Message Encoding (SAME) codes, and still other embodiments use Zone Improvement Plan (ZIP) codes from the United States Postal Service. Other types of geo-codes may be used.

Other novel features of further embodiments of the emergency alert location filtering system and method include predictive filtering of emergency alerts and other emergency notification. Embodiments of the system and method use a GPS or other type of navigational system to locate an automotive or other type of mobile device and predict the route of travel based on learned patterns of past trips and using an advanced location database.

Embodiments of the emergency alert location filtering system and method include a digital radio device with the ability to determine location coordinates and/or utilize route or destination information to dynamically adjust geo-location filtering of digital radio emergency alerts by aligning predictive location with geo-code databases (FIPS, SAME, ZIP, and other). The device and method include the ability to carry out the following: determine latitude and longitude of a current position and/or selected route and destination, map coordinates of drive prediction to existing geocode databases to extract appropriate polygon codes for desired location/destination/route, filter geocoded alert messages based on predetermined polygon codes and present the appropriate messages to the HMI or display, and repeat the process and update the predicted location polygons based on latest position and route information.

As discussed above, the filter may be configured such that alert messages are allowed to pass that comprise a geographical code which corresponds to the geographical area in which the current geographical location of the user device is located (i.e., in which the user device is currently located). To decide if the geographical code of the alert message corresponds to a geographical area in which the user device is currently present, alternative methods may be implemented. Either, the geographical code of the alert message is mapped/converted to a geographical area and this geographical area is compared with the current location of the user device, or the current location of the user device is mapped/converted to a geographical area and the geographical code of that area is compared to the geographical code of the alert message. Accordingly, either the geographical areas/positions or the geographical codes are compared.

Accordingly, in an embodiment, the geographical code of the alert message is converted to a corresponding geographical area, wherein the configuring step comprises configuring the filter to allow alert messages to pass the filter if the current geographical location of the user device lies within the determined geographical area.

Accordingly, in another embodiment, the method further comprises mapping the current geographical location of the user device to a corresponding geographical area, wherein the geographical area is associated with a geographical code; and determining the geographical code of the mapped geographical area; wherein the configuring step comprises configuring the filter to allow alert messages to pass the filter that comprise a geographical code which corresponds to the determined geographical code.

In a further embodiment, the filter is configured to further allow alert messages to pass the filter that comprise a geographical code which corresponds to a geographical area adjacent the geographical area in which the current geographical location of the user device is located. This embodiment allows to bring alert messages to the attention of a user which regard geographical areas that neighbor the geographical area in which the user device is presently located. This is based on the rationale that a user/user device may be moving to a neighboring geographical area such that it is relevant to receive alert messages that regard neighboring geographical areas. To receive alert messages that regard adjacent geographical areas, the geographical codes of the adjacent geographical areas are determined.

In a further embodiment, the method further comprises determining an expected route of travel along which the user device will travel; and configuring the filter to further allow those alert messages to pass the filter that comprise geographical codes which corresponds to geographical areas that are passed along the expected route of travel. This embodiment allows to dynamically adjust an alert filter in accordance with a route that the user device is traveling and allows to inform a user about all alerts that are relevant for the user along the route which the user is taking (without notifying the user about alerts that are irrelevant for him), wherein the method is flexible as to any changes in the route.

Again, as discussed above, either the geographical areas/positions or the geographical codes may be compared to determine which alert messages comprise geographical codes that correspond to geographical areas that are passed along the expected route of travel. Accordingly, in an embodiment, the method further comprises converting the geographical code of the alert message to a corresponding geographical area, wherein the configuring step comprises configuring the filter to allow alert messages to pass the filter if the expected route of travel passes the determined geographical area.

Alternatively, the method further comprises mapping the expected route of travel to a plurality of geographical areas that are passed long the expected route of travel, wherein each geographical area is associated with a geographical code; and determining the geographical codes of the respective geographical areas. The configuring step comprises configuring the filter to further allow alert messages to pass the filter that comprise geographic codes which correspond to the determined geographical codes.

In such method, the mapping step may comprise to determine a plurality of geographical locations that need to be passed along the expected route of travel; and to map these geographical locations to geographical areas. Such geographical locations may include the current position of the user device and at least one further geographical location along the expected route of travel, such as intermediate locations along the route and the destination location. The geographical locations are determined with a sufficiently narrow grid to ensure that all geographic areas between the current location and the destination location are considered and that alert messages for all these geographic areas are received.

In a further embodiment, mapping the geographical locations to geographical areas may comprise identifying the geographical locations in a database of geographical codes. The database may be a database of FIPS, SAME, ZIP or other geographical codes and associated geographical areas.

In an embodiment, determining an expected route of travel may comprise receiving current location data, route data and/or destination data. More particularly, the expected route of travel may be determined using a navigational system into which the current location and a destination location are input. In another embodiment, predictive tracking may be implemented to determine an expected route of travel. For example, the user device may track, store and learn particular driving patterns of a user, such as the user typically driving a particular route at a particular time of day. For example, if a user starts the car in the morning time during the week, an expected route of travel may be defined simply by that fact, assuming that the user will drive the car to work.

The mentioned process steps of the different embodiments may be repeated constantly or within defined time intervals, wherein the geographical codes and the geographical areas that allow the alert messages to pass the alert filter are updated based on latest position and/or route information.

The geographical areas that are considered have a defined size and geographical coverage. They may be formed as polygons, such as hexagons.

In an embodiment, the user device is an automotive digital radio broadcast receiver. In another embodiment, the user device is a mobile device such as a smartphone or tablet computer.

The alert messages may be received through a digital radio broadcast network in a manner known to the person skilled in the art. For example, document U.S. Pat. No. 8,138,915 B2, the entire content of which is incorporated herewith by reference, discloses broadcasting emergency alerts through conventional and digital radio broadcasting systems. However, the present invention is not limited to particular ways in which alert messages are received. For example, alternatively, the alert messages may be received through a computer network.

In a further embodiment, the alert messages further comprise a category type code, wherein the category type code identifies a category of the message information conveyed by the alert message. It may be provided that the alert message is rendered at the user device only if the category of the message corresponds to a preselected category. Preselection of the category may be made by a user of the user device. This embodiment allows to filter the alert messages for specific types of alert messages.

The alert messages may be rendered at the user device through a human machine interface such as a display and/or audio equipment.

### BRIEF DESCRIPTION OF THE DRAWINGS

Throughout the drawings, reference numbers are re-used to indicate correspondence between referenced elements. The drawings are provided to illustrate embodiments of the inventions described herein and not to limit the scope thereof.

FIG. 1 illustrates a route of travel of a user device through a plurality of geographical areas with polygonal shape, wherein alert messages are provided in some of the geographical areas.

FIG. 2 illustrates a vehicle that comprises a user device which receives digital radio broadcast signals and GPS signals.

FIG. 3 is a system block diagram of an emergency alerts location filtering system.

FIG. 4 illustrates a method for rendering alert messages at a user device, wherein alert messages are provided for a current geographical location of a user device.

FIG. 5 illustrates a further method for rendering alert messages at a user device, wherein alert messages are provided for a current geographical location of a user device and adjacent geographical areas.

FIG. 6 illustrates a still further method for rendering alert messages at a user device, wherein alert messages are provided for geographical areas along a route of travel of a user device.

FIG. 7 illustrates a still further method for rendering alert messages at a user device, wherein a current position of a user device is evaluated relative to a geographical area associated with a received alert message.

FIG. 8 illustrates a still further method for rendering alert messages at a user device, wherein a geographical code of a geographical area which comprises a current position of a user device is evaluated relative to a geographical code of a received alert message.

FIG. 9 illustrates a still further method for rendering alert messages at a user device, wherein a route of travel of a user device is evaluated relative to a geographical area associated with a received alert message.

FIG. 10 illustrates a still further method for rendering alert messages at a user device, wherein the geographical codes of geographical areas along a route of travel are evaluated relative to a geographical code of a received alert message.

FIG. 11 illustrates a still further method for rendering alert messages at a user device, wherein alert messages are provided for a current geographical location of a user device and adjacent geographical areas.

### DETAILED DESCRIPTION

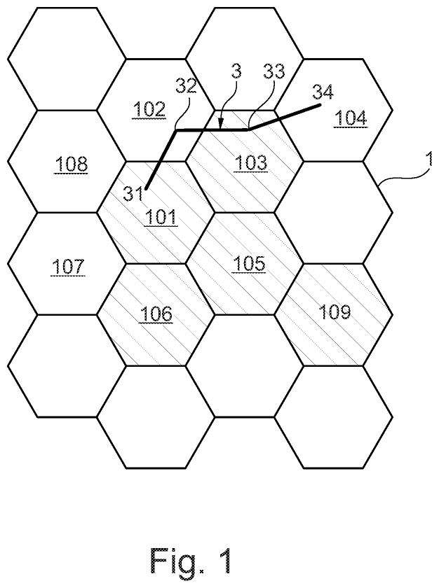

As described above in the Background and Summary, the present invention provides for emergency alert location filtering systems and methods. One potential scenario underlying the present invention is discussed with respect to FIG. 1. FIG. 1 depicts a part of the earth's surface which is divided into a plurality of adjacent geographical areas 1, each of which is associated with a particular geographical code. Examples of the geographical codes associated with the geographical areas 1 are Federal Information Processing System (FIPS) codes, Specific Area Message Encoding (SAME) codes, and Zone Improvement Plan (ZIP) codes.

The geographical areas 1 comprise a polygonal shape, namely, hexagonal shape. However, such form of the geographical areas 1 is to be understood as an example only. In other embodiments, the geographical areas one may comprise different forms. Also, it may be provided that the geographical areas 1 overlap to some extent.

FIG. 1 depicts a route 3 which a user device such as an automotive digital radio broadcast receiver or a mobile device may take. The route 3 has a starting point 31, a designation point 34 and geographical points 32, 33 in between. The starting point 31 is located in geographical area 101, geographical point 32 is located in geographical area 102, geographical point 33 is located in geographical area 103 and designation point 34 is located in geographical area 104.

As mentioned, each geographical area 1 is associated with a particular geographical code. The geographical codes are used by an emergency alert system that provides alert messages and allows the emergency alert system to make emergency alerts to be location specific, i.e., each geographical area may be provided with different alert messages. This is sensible to ensure that alert messages are provided to the particular geographical area only to which they pertain. For example, an alert message regarding a wrong way driver or a fire alarm are only of interest for the particular geographical area in which these situations are present.

It is pointed out that the alert messages may comprise further message parts such as a message part that comprises a category type code, wherein the category type code identifies a category of the message information. A user may select that only alert messages of a particular category type are brought to the user's attention. Alert message formats that may be used in the context of the present invention are described, e.g., in document U.S. Pat. No. 8,138,915 B2, the entire content of which is incorporated herewith by reference.

In FIG. 1, a moment display is provided in that only the dashed geographical areas 101, 103, 105, 106, 109 receive one or several alert messages through an emergency alert system, wherein other geographical areas do not receive any alert messages at a considered time.

There is a desire that a user device which is traveling from starting point 31 to designation point 34 receives, along its route, alert messages for the particular geographical area in which he is presently traveling. There may be a further desire that the user device not only receives alert messages for the geographical area in which he is presently traveling, but also with respect to geographical areas that the user will pass along the route, including the geographical area of the destination point. On the other hand, the user device or its user is not interested in alert messages that are provided for in geographical areas which the user is not passing and which are not relevant for him. For example, in the embodiment of FIG. 1, the user would be interested in receiving the alert messages for geographical areas 101 and 103 only.

In still another embodiment, a user, when entering the vehicle and starting a drive from starting point 31, may not have any particular direction to go or may have no intention to define a route of travel through a navigational system. In such case, the user would be interested in receiving alert messages for the geographical area in which the user presently is and also for neighboring geographical areas that the user may not pass during his drive.

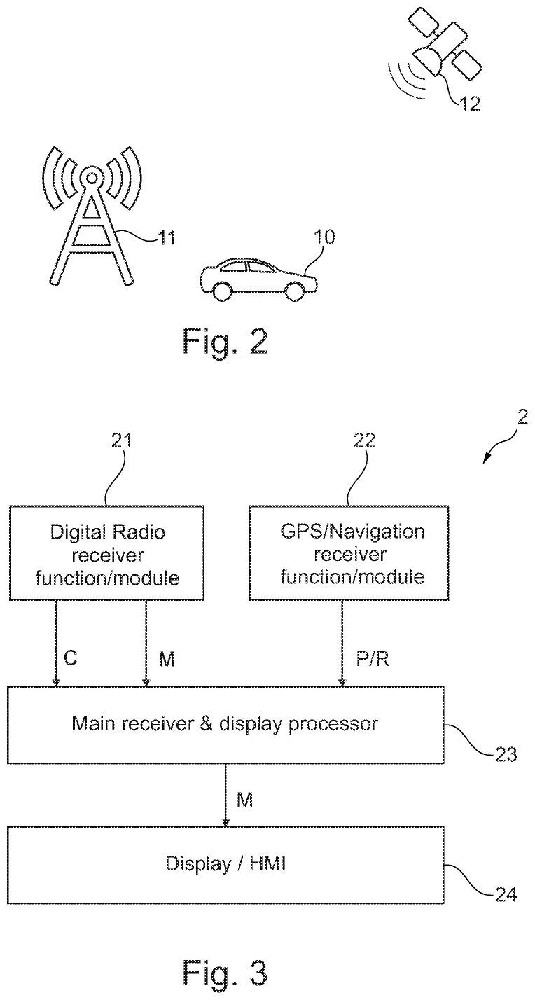

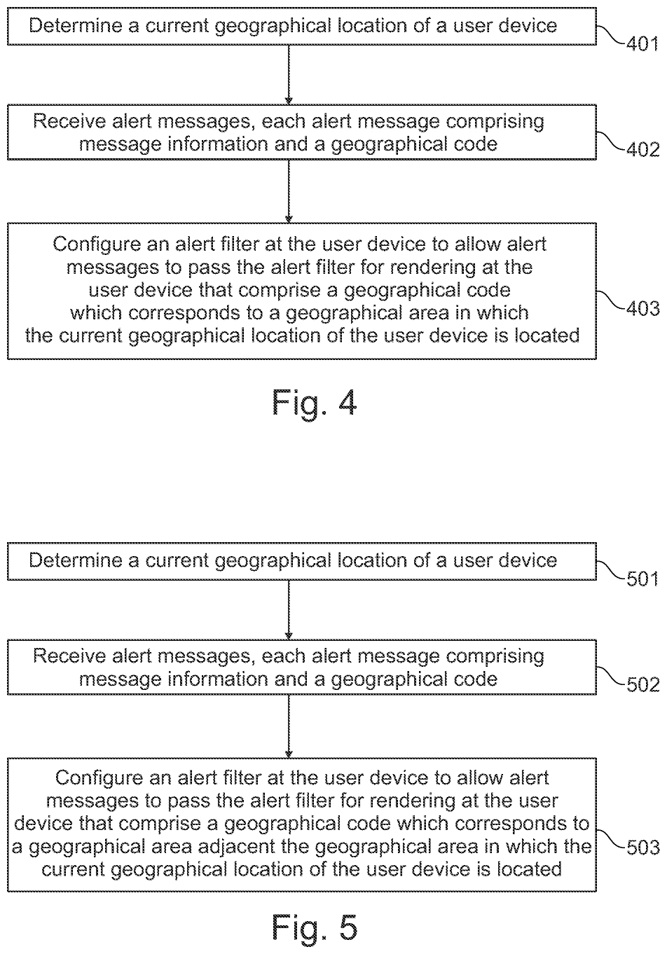

The manner in which a user device receives alert messages in the different depicted scenarios will be discussed with respect to the methods of FIGS. 4 to 10. Before discussing these figures and methods, the required communication links and filtering system are discussed with respect to FIGS. 2 and 3.

FIG. 2 depicts a vehicle 10. Integrated into the vehicle 10 is an emergency alert location filtering system described with respect to FIG. 3. The vehicle 10 and its emergency alert location filtering system receive over-the-air digital radio broadcast signals from a digital radio broadcast station 11. The over-the-air digital radio broadcast signals can be analog audio signals, digital audio signals, or hybrid audio signals. The vehicle and its emergency alert location filtering system further receive GPS or other navigational signals from a satellite 12.

The digital radio broadcast signals broadcast by broadcast station 11 include alert messages, wherein the alert messages comprise at least message information and a geographical code, the geographical code being specific to geographical areas such as geographical areas 1 depicted in FIG. 1. The alert messages may be included in the digital radio broadcast in a plurality of ways as is known to the skilled person. For example, the alert messages may be provided in one or several specific channels of the broadcast, may be interleaved with main program signals, or may be provided by metadata.

Further, in alternative embodiments not depicted in FIG. 2, the alert messages may be provided through a computer network such as the Internet in a data stream. In such case, the vehicle 10 and its emergency alert location filtering system may be connected to the Internet, e.g., through a wireless network.

FIG. 3 depicts an embodiment of an emergency alert location filtering system 2. The filtering system 2 may be implemented in a radio receiver such as an automotive digital radio broadcast receiver such as HD Radio™, DAB+, DRM, CDR, and many others. The filtering system 2 may also be implemented as an application software in a mobile device such as a smart phone or a laptop computer. The filtering system 2 comprises a digital radio receiver function/module 21, a GPS/navigation receiver function/module 22, a main receiver & display processor 23, and a display/HMI 24.

The digital radio receiver function/module 21 is configured to receive alert messages that comprise message information M and a geographical code C. The GPS/navigation receiver function/module 22 is configured to determine a current geographical location of the user device based on received GPS data. The GPS/navigation receiver function/module 22 is further configured to determine a route between a current geographical location and a destination geographical location, such as between locations 31 and 34 of FIG. 1. Such route is also referred to as expected route of travel. To this end, a conventional navigation software may be implemented or used by GPS/navigation receiver function/module 22, wherein a desired destination point is input and the GPS/navigation receiver function/module 22 calculates one or several routes from the current geographical location to the destination geographical location. Route 3 of FIG. 1 is an example of such calculated route.

The main receiver & display processor 23 comprises a processor and a memory which stores instructions that, when executed by the processor, configure the processor to carry out particular method steps as will be discussed with respect to FIGS. 4 to 11. The main receiver & display processor 23 receives as input the message information M and the geographical code C of the alert messages received by digital radio receiver function/module 21. The main receiver & display processor 23 further receives as input the current position information P and/or route information R from GPS/navigation receiver function/module 22. In this respect, it is pointed out that receiving route information R implies that also current position information P is received as the current position information is part of the route information.

The main receiver & display processor 23 provides as output the alert message information M of the received alert message for display at display/HMI 24, if the received alert message satisfies specific conditions as determined by main receiver & display processor 23 in accordance with the routines, e.g., of FIGS. 4 to 11. Accordingly, the main receiver & display processor 23 acts as an alert filter for alert messages received by digital radio receiver function/module 21.

The display/HMI 24 may be any human machine interface. Examples include a display, a combined display/audio HMI or an only audio HMI. For example, in a combined display/audio HMI or an only audio HMI a current program may be interrupted for announcing an alert message created by computerized voice generation. The main receiver & display processor 23 filters the received alert messages

FIG. 4 depicts method steps of a method implemented by main receiver & display processor 23 in combination with digital radio receiver function/module 21, GPS/navigation receiver function/module 22, and display/HMI 24. In step 401, a current geographical location of a user device is determined. This may be implemented through GPS/navigation receiver function/module 22. In step 402, alert messages are received, wherein each alert message comprises message information and a geographical code. This may be implemented through digital radio receiver function/module 21. In step 403, an alert filter is configured at the user device to allow alert messages to pass the alert filter for rendering at the user device. Those alert messages are allowed to pass the filter that comprise a geographical code which corresponds to a geographical area in which the current geographical location of the user device is located. Such a filter is provided by the process steps of main receiver & display processor 23. The alert messages that are rendered at the user device are rendered by indicating them at the display/HMI 24.

The embodiment of FIG. 4 thus allows those alert messages to pass the alert filter which correspond to a geographical area in which the user device is presently located. Referring to the embodiment of FIG. 1, alert signal for geographical area 101 would be received as long as the mobile device is in geographical area 101. Along its route 3, the mobile device would receive alert signals for geographical areas 102, 103 and 104 when in the respective geographical area.

FIG. 5 depicts a further method for rendering an alert message at a user device. Steps 501 and 502 are identical to steps 401 and 402 of FIG. 4, such that reference is made to FIG. 4 in this respect. In step 503, an alert filter is configured at the user device to allow alert messages to pass the alert filter for rendering at the user device. Those alert messages are allowed to pass the filter which correspond to a geographical area adjacent the geographical area in which the current geographical location of the user device is located (and including the geographical area of the current geographical location). Referring to the embodiment of FIG. 1, alert signals for geographical areas 101, 102, 103, 105, 106, 107 and 108 would be received at the user device as long as the user device has its current geographical location in geographical area 101. Such embodiment is sensible in situations in which a driver starts driving his car without having defined a particular route that he intends to take. The driver receives alert messages for the geographical area in which he is presently located and further for neighboring geographical areas such that he becomes aware of potential hazards when driving in particular directions.

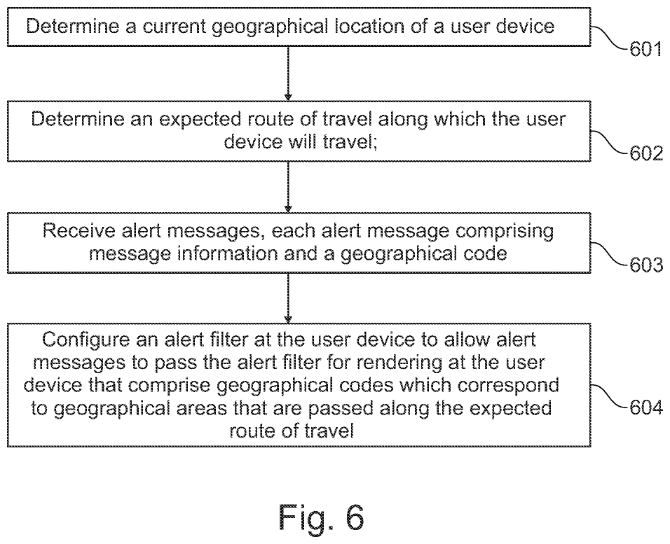

FIG. 6 depicts a further method for rendering an alert message at a user device. In step 601, a current geographical location of a user device is determined. In step 602, an expected route of travel along which the user device intends to travel is determined. Such expected route of travel may be determined by the navigational function of module 22 of FIG. 3. In this respect, it is pointed out that steps 601, 602 may take place simultaneously, as determining an expected route of travel implies determining the current geographical location.

Step 603 is identical to step 402 of FIG. 4. In step 604, an alert filter is configured at the user device to allow alert messages to pass the alert filter for rendering at the user device. Those alert messages are allowed to pass the filter that comprise geographical codes which correspond to geographical areas that are passed along the expected route of travel. Referring to the embodiment of FIG. 1, with the method of FIG. 6, alert signals for geographical areas 101, 102, 103 and 104 are rendered at the user device, such that the user receives alert messages for all geographical areas which he passes along the expected route of travel.

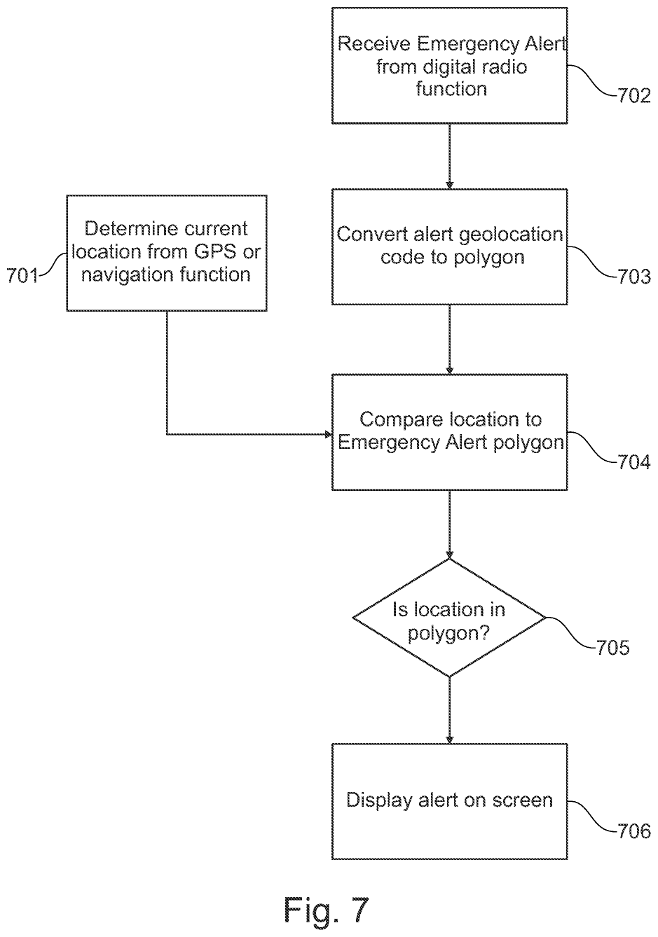

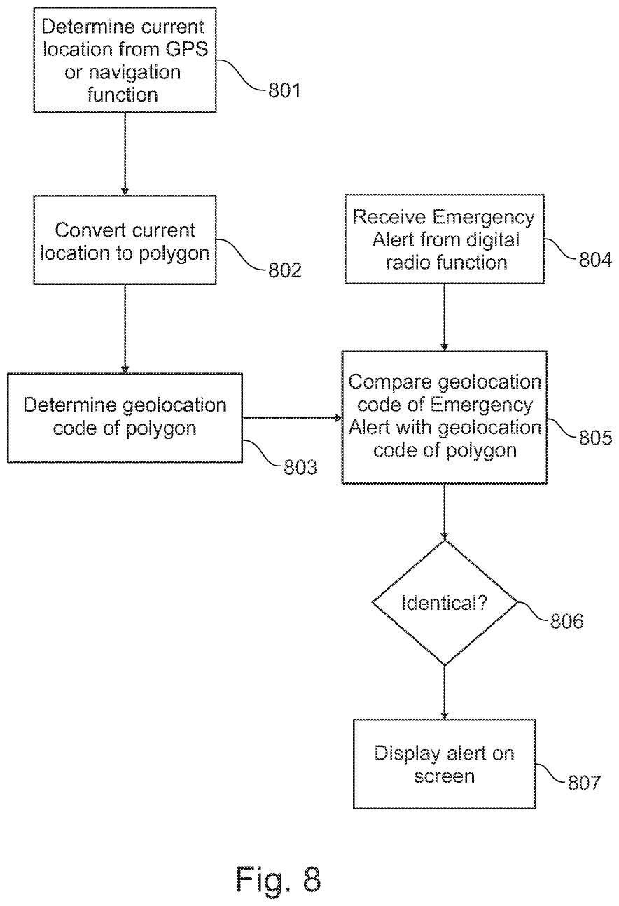

While FIGS. 4 to 6 depicted different methods for rendering alert messages in a general manner, such methods will be discussed in more detail with respect to FIGS. 7 to 11. FIG. 7 and FIG. 8 depict methods for rendering alert messages which are in general agreement with the method of FIG. 4.

In the method of FIG. 7, a current location of a user device is determined in step 7 1 from a GPS or navigation function, such as through GPS/navigation receiver function/module 22 of FIG. 3. Determining the current position may include obtaining the latitude and longitude coordinates of the user device. In step 702, an emergency alert message from a digital radio function is received, such as through digital radio receiver function/module 21 of FIG. 3. The received message comprises message information and a geographical code. In step 703, the geographical code (also known as “geolocation code” and identified as geolocation code in FIG. 7) of the received alert message is converted into a corresponding geographical area, the geographical area being referred to as “polygon” in FIG. 7 (and also in FIGS. 8 to 11) as a polygon one form of a geographical area associated with a particular geographical code as shown in FIG. 1.

In step 704, the current location of the user device is compared to the geographical area or polygon associated with the emergency alert message received at step 702. If the current location lies in the polygon associated with the received emergency alert message, step 705, the alert message is provided to a display screen, step 706. It could additionally or alternatively be indicated in an audio format.

In FIG. 8, the method is in principle the same as in FIG. 7. However, it is not the geographical area/polygon associated with a received geolocation code that is evaluated, but geolocation codes themselves are evaluated. In step 801, a current location of a user device is determined from a GPS or a navigational function, such as in step 701 of FIG. 7. In step 802, the current location of the user device is converted/mapped to the geographical area/polygon that comprises the current location. To this end, it is determined in which geographical area the user device is currently located using GPS or similar information. The geographical areas are predefined areas of a defined size, and are each associated with a geographical code, such as Federal Information Processing System (FIPS) codes, Specific Area Message Encoding (SAME) codes, and Zone Improvement Plan (ZIP) codes, as discussed before. Subsequently, in step 803, the geographical code of the mapped geographical area/polygon is determined. To this end, e.g., a database may be consulted that comprises the respective geographical codes and areas.

Emergency alert messages are received in step 804 from a digital radio function, such as in step 702 of FIG. 7. In step 805, it is the respective geographical codes that are compared. More particularly, the geographical code (geolocation code) of the received emergency alert message is compared with the geographical code associated with the geographical area in which the mobile device is presently located as determined in step 803. If the geographical codes are identical, step 806, the alert message is provided to a display screen, step 807. It could additionally or alternatively be indicated in an audio format.

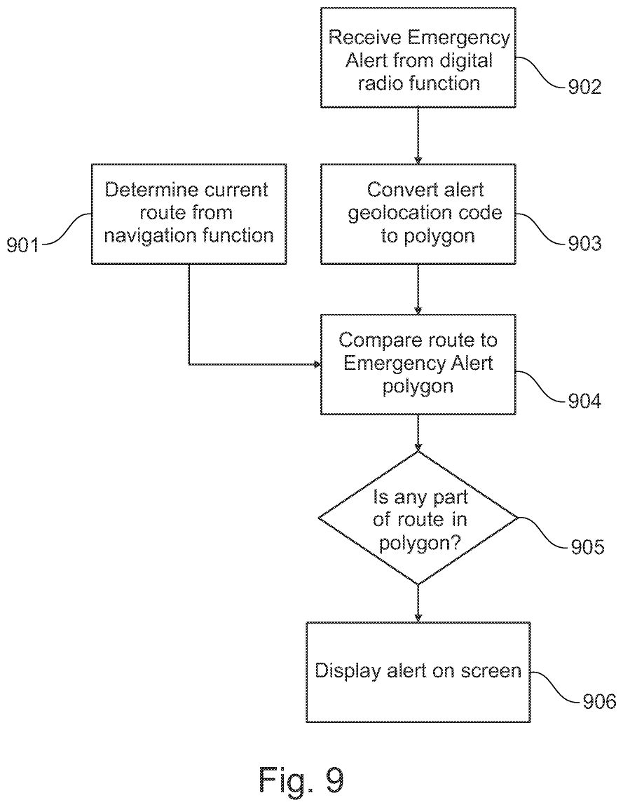

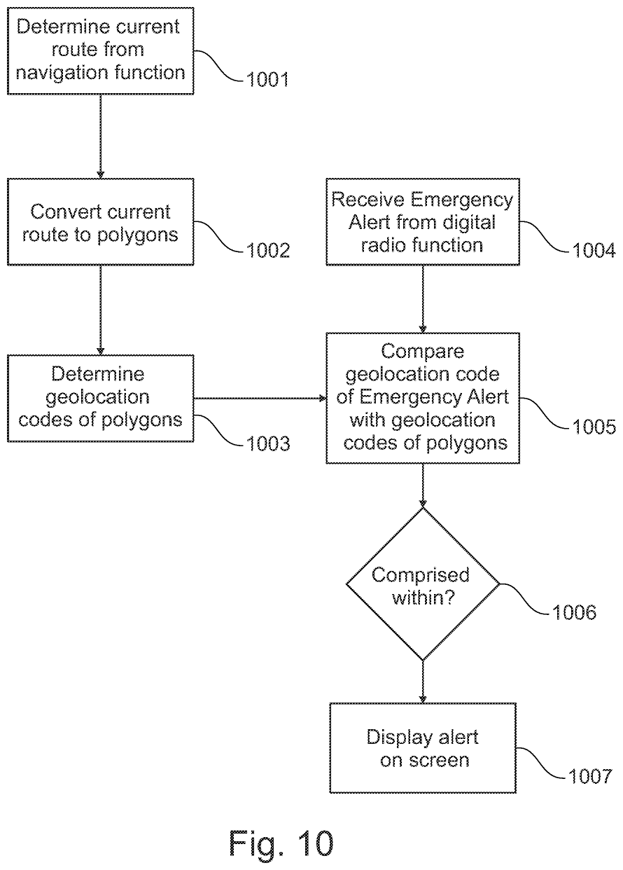

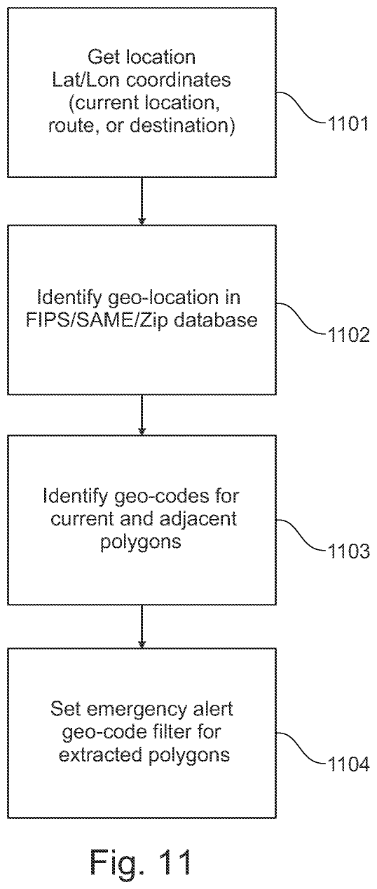

FIG. 9 and FIG. 10 depict methods for rendering alert messages which are in general agreement with the method of FIG. 6. In the method of FIG. 9, an expected (current) route of travel is determined in step 901 from a navigation function, such as through GPS/navigation receiver function/module 22 of FIG. 3. In step 902, an emergency alert message from a digital radio function is received, such as through digital radio receiver function/module 21 of FIG. 3. The received message comprises message information and a geographical code. In step 903, the geographical code (identified as geolocation code in FIG. 9) of the received alert message is converted into a corresponding geographical area, the geographical area being referred to as “polygon” in FIG. 9.

In step 904, the expected route of travel of the user device is compared to the geographical area or polygon associated with the emergency alert message received in step 902. If the expected route of travel passes the geographical area/polygon associated with received emergency alert message, step 905, the alert message is provided to a display screen, step 906. It could additionally or alternatively be indicated in an audio format.

In FIG. 10, the method is in principle the same as in FIG. 9. However, it is not the geographical area/polygon associated with a received geolocation code that is evaluated, but geolocation codes themselves are evaluated. More particularly, in step 1001, an expected (current) route of travel of a user device is determined from a navigational function, such as in step 901 of FIG. 9. In step 1002, the expected route of travel is converted/mapped to the geographical areas/polygons that are passed along the expected route of travel. To this end, for example, a plurality of geographical locations that need to be passed along the expected route of travel may be determined using the navigation function, such as geographical locations 31, 32, 33 and 34 of route 3 of FIG. 1. These geographical locations are then mapped to geographical areas or polygons that are each associated with a respective geographical code such as FIPS codes, SAME codes, and ZIP codes.

Subsequently, in step 1003, the geographical codes of the mapped geographical areas/polygons that are passed along the expected route of travel are determined. To this end, e.g., a database may be consulted that comprises the respective geographical codes and areas.

Emergency alert messages are received in step 1004 from a digital radio function, such as in step 902 of FIG. 9. In step 1005, it is the respective geographical codes that are compared. More particularly, the geographical code (geolocation code) of the emergency alert message received in step 1004 is compared with the geographical codes associated with the geographical areas that are passed along the expected route of travel as determined in step 1003. If the geographical code associated with the received alert message is comprised within the geographical codes determined in step 1003, step 1006, the alert message is provided to a display screen, step 1007. It could additionally or alternatively be indicated in an audio format.

FIG. 11 depicts a method for rendering alert messages which is in general agreement with the method of FIG. 5. As shown in FIG. 11, in step 1101, a current geographical location of a user device is determined by receiving latitude and longitude coordinates. Additional data may be received regarding an intended route of travel or a destination. In step 1102, the determined geographical location (geo-location) is identified in a database of geographical codes and associated areas, such a database of FIPS, SAME or ZIP geo-codes. Using such database, it is determined with which geographical area the current geo-location of the user device is associated with. This may be done, e.g., by determining if the latitude and longitude coordinates of the current location lie within defined ranges that identify the geographical areas.

In step 1103, using the database, the respective geographical code (geo-code) of the geographical area associated with the current geo-location of the user device is identified. In addition, the geo-codes for the adjacent geographical areas/polygons are identified, such as for polygons 102, 103, 105, 106, 107 and 108 in FIG. 1. These polygons then are extracted. According to step 1104, embodiments of the method then set an emergency alert geo-code filter for the extracted polygons. This limits the deployment of any emergency alerts to a targeted geographical area that is relevant to the current or upcoming location of the automobile or mobile device.

The methods of all of FIGS. 4 to 11 may be updated constantly or in defined time intervals by repeating the process steps and updating the geographical area or areas that allow alert messages to pass the alert filter based on the latest position information and/or route information.

### Alternate Embodiments and Exemplary Operating Environment

Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the system and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Bluray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal. Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the system and method described herein, or portions thereof, may be stored, received, transmitted, or read from any desired combination of computer or machine readable media or storage devices and communication media in the form of computer executable instructions or other data structures.

Embodiments of the system and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

1. A method for rendering an alert message at a user device that is in a moving condition, the method comprising:
determining a current geographical location of the user device;
receiving alert messages, each alert message comprising message information and a geographical code; and
configuring an alert filter at the user device to allow alert messages to pass the alert filter for rendering at the user device that comprise a geographical code which corresponds to a geographical area in which the current geographical location of the user device is located.

2. The method of claim 1, further comprising converting the geographical code of the alert message to a corresponding geographical area, wherein the configuring step comprises configuring the filter to allow alert messages to pass the filter if the current geographical location of the user device lies within the determined geographical area.

3. The method of claim 1, further comprising:
mapping the current geographical location of the user device to a corresponding geographical area, wherein the geographical area is associated with a geographical code;
determining the geographical code of the mapped geographical area;
wherein the configuring step comprises configuring the filter to allow alert messages to pass the filter that comprise a geographical code which corresponds to the determined geographical code.

4. The method of claim 1, wherein the filter is configured to further allow alert messages to pass the filter that comprise a geographical code which corresponds to a geographical area adjacent the geographical area in which the current geographical location of the user device is located.

5. The method of any of claim 1, further comprising:
determining an expected route of travel along which the user device will travel;
configuring the filter to further allow alert messages to pass the filter that comprise geographical codes which correspond to geographical areas that are passed along the expected route of travel.

6. The method of claim 5, further comprising converting the geographical code of the alert message to a corresponding geographical area, wherein the configuring step comprises configuring the filter to allow alert messages to pass the filter if the expected route of travel passes the determined geographical area.

7. The method of claim 5, further comprising:
mapping the expected route of travel to a plurality of geographical areas that are passed along the expected route of travel, wherein each geographical area is associated with a geographical code;
determining the geographical codes of the respective geographical areas;
wherein the configuring step comprises configuring the filter to further allow alert messages to pass the filter that comprise geographic codes which correspond to the determined geographical codes.

8. The method of claim 7, wherein the mapping step comprises:
determining a plurality of geographical locations that need to be passed along the expected route of travel; and
mapping these geographical locations to geographical areas.

9. The method of claim 8, wherein determining a plurality of geographical locations comprises determining the geographical location of the current position of the user device and at least one further geographical location along the expected route of travel.

10. The method of claim 8, wherein mapping the geographical locations to geographical areas comprises identifying the geographical locations in a database of geographical codes.

11. The method of claim 5, wherein determining an expected route of travel comprises receiving current location data, route data and/or destination data.

12. The method of claim 5, wherein the expected route of travel is determined using a navigational system.

13. The method of claim 5, wherein the expected route of travel is determined based on behavioral patterns of a user of the user device.

14. The method of claim 1, further comprising repeating the process and updating the geographical area that allows the alert messages to pass the filter based on latest position and/or route information.

15. The method of claim 1, wherein the geographical codes associated with the geographical areas include at least one of Federal Information Processing System (FIPS) codes, Specific Area Message Encoding (SAME) codes, and Zone Improvement Plan (ZIP) codes.

16. (canceled)

17. (canceled)

18. (canceled)

19. (canceled)

20. The method of claim 1, wherein the alert messages further comprise a category type code, wherein the category type code identifies a category of the message information conveyed by the alert message, and wherein the alert message is rendered at the user device only if the category of the message corresponds to a preselected category.

21. (canceled)

22. An emergency alert location filtering system of a user device comprising:
a receiver module configured to receive alert messages that comprise message information and a geographical code;
a GPS/navigational module configured to determine a current geographical location of the user device and/or configured to determine a route between a current geographical location and a destination geographical location;
a human machine interface;
a processor coupled to the receiver module, the GPS/navigational module and the human machine interface; and
a memory storing instructions that, when executed by the processor, configure the processor to:
allow alert messages to pass from the receiver module to the human machine interface that comprise a geographical code which corresponds to a geographical area in which the current geographical location of the user device is located.

23. The system of claim 22, the instructions further configuring the processor to convert the geographical code of the alert message to a corresponding geographical area, and allow alert messages to pass to the human machine interface if the current geographical location of the user device lies within the determined geographical area.

24. The system of claim 22, the instructions further configuring the processor to:
map the current geographical location of the user device to a corresponding geographical area, wherein the geographical area is associated with a geographical code;
determine the geographical code of the mapped geographical area;
allow alert messages to pass to the human machine interface that comprise a geographical code which correspond to the determined geographical code.

25. The system of claim 22, the instructions further configuring the processor to allow alert messages to pass to the human machine interface that comprise a geographical code which corresponds to a geographical area adjacent the geographical area in which the current geographical location of the user device is located.

26. (canceled)

27. (canceled)

28. (canceled)

29. (canceled)

30. (canceled)

31. (canceled)

32. (canceled)

33. (canceled)

34. (canceled)

35. (canceled)
